(19) United States
(12) Patent Application Publication
(10) Pub. No.: US 2012/0162168 A1
(43) Pub. Date: Jun. 28, 2012

(54) METHOD OF SETTING GAMMA OF DISPLAY DEVICE

(76) Inventors: Suil Ku, Seoul (KR); Changhung Lee, Gyeongju-si (KR)

(21) Appl. No.: 13/333,519

(22) Filed: Dec. 21, 2011

(30) Foreign Application Priority Data
Dec. 27, 2010 (KR) 10-2010-0135804

(51) Int. Cl. G06F 3/038

(52) U.S. Cl. 345/207

(57) ABSTRACT

A method of setting gamma of a display device comprises: sensing an optical characteristic from a display module; comparing a color coordinate the sensing of an optical characteristic and a target color coordinate and determining a fluctuation value of R gamma and a fluctuation value of G gamma; determining whether the fluctuation value of R gamma and the fluctuation value of G gamma determined at the determining of a fluctuation value satisfy an allowable error; first correcting of correcting the fluctuation value of R gamma and the fluctuation value of G gamma and lowering or raising according to the fluctuation values of R, G and B gamma; second correcting of lowering or raising according to the fluctuation values of a corrected R, G and B gamma; and applying R gamma, G gamma, and B gamma corrected at the second correcting to the display module.

Pursuant to 35 U.S.C. §119(a), this application claims the benefit of earlier filing date and right of priority to Korean Application 10-2010-0135804 filed on Apr. 22, 2011, the content of which is incorporated by reference herein in its entirety.

### BACKGROUND

1. Field of the Invention

This document relates to a method of setting gamma of a display device.

2. Discussion of the Related Art

As information technology develops, the market for a display device, which is a connection medium between a user and information increases and thus use of a display device such as an organic light emitting display (OLED), a liquid crystal display (LCD), and a plasma display panel (PDP) has increased.

The display device is used in various industrial fields of a mobile phone or a computer such as a notebook computer as well as a household appliance field such as a television (TV) or a video recorder.

In order to express desired luminance and color coordinate, a display device generally sets a gamma value (corrects a color) and stores the set gamma value in a memory, and displays a screen with reference to the gamma value stored in the memory whenever driving.

Conventionally, in order to set a target color coordinate of a panel and to adjust internal gamma of a data driver, by adjusting only RG gamma of red color, green color, and blue color (RGB) gamma, a color coordinate was set. Because the related art changes only RG gamma, when setting gamma, RG gamma arrives at a gamma minimum value or a gamma maximum value and thus the RG gamma may be no longer changed.

In this way, because the related art sets a color coordinate using only two RG gamma, a time required for approaching a target color coordinate is longer than that when using all three RGB gamma.

However, in order to use all RGB gamma, conventionally used devices should be changed for compatibility of firmware on a control board as well as an operating program of a person computer (PC), but this is uneasy in view of technical difficulty of algorithm, etc., and as a program becomes complex, much difficulty in solving problems that may occur exists.

Therefore, conventionally, a method of setting gamma for expressing luminance and a color coordinate using only two RG gamma due to the above-described problems should have been continuously used.

### BRIEF SUMMARY

In an aspect, a method of setting gamma of a display device, the method comprises: sensing an optical characteristic from a display module; comparing a color coordinate sensed at the sensing of an optical characteristic and a target color coordinate and determining a fluctuation value of R gamma and a fluctuation value of G gamma; determining whether the fluctuation value of R gamma and the fluctuation value of G gamma determined at the determining of a fluctuation value satisfy an allowable error; first correcting of correcting, if the fluctuation value of R gamma and the fluctuation value of G gamma do not satisfy an allowable error, the fluctuation value of R gamma and the fluctuation value of G gamma, and lowering, if the fluctuation value of R gamma and the fluctuation value of G gamma is a positive number, a fluctuation value of B gamma, and raising, if the fluctuation value of R gamma and the fluctuation value of G gamma is a negative number, a fluctuation value of B gamma; second correcting of lowering, if one of the fluctuation value of R gamma and the fluctuation value of G gamma arrives at a gamma maximum value, through the first correction, the fluctuation value of B gamma, and raising, if one of the fluctuation value of R gamma and the fluctuation value of G gamma arrives at a gamma minimum value, the fluctuation value of B gamma, and lowering, if the fluctuation value of B gamma arrives at a gamma maximum value, the fluctuation value of R gamma and the fluctuation value of G gamma, and raising, if the fluctuation value of B gamma arrives at a gamma minimum value, the fluctuation value of R gamma and the fluctuation value of G gamma; and applying R gamma, G gamma, and B gamma corrected by the second correcting to the display module.

### BRIEF DESCRIPTION OF THE DRAWINGS

The accompany drawings, which are comprised to provide a further understanding of the invention and are incorporated on and constitute a part of this specification illustrate implementations of the invention and together with the description serve to explain the principles of the invention.

FIG. 1 is a schematic block diagram illustrating a display device according to an implementation of this document;

FIG. 2 is a diagram illustrating a subpixel circuit configuration of an OLED panel according to an implementation of this document;

FIG. 3 is a diagram illustrating a subpixel circuit configuration of an LCD panel according to an implementation of this document;

FIG. 4 is a diagram illustrating a configuration of a device for setting gamma of a display device according to an implementation of this document;

FIG. 5 is a flowchart illustrating a method of setting gamma according to an implementation of this document; and

FIGS. 6 and 7 are flowcharts illustrating a method of setting gamma according to an implementation of this document.

### DETAILED DESCRIPTION OF THE DRAWINGS AND THE PRESENTLY PREFERRED EMBODIMENTS

Reference will now be made in detail implementations of the invention examples of which are illustrated in the accompanying drawings.

Hereinafter, an implementation of this document will be described in detail with reference to the attached drawings.

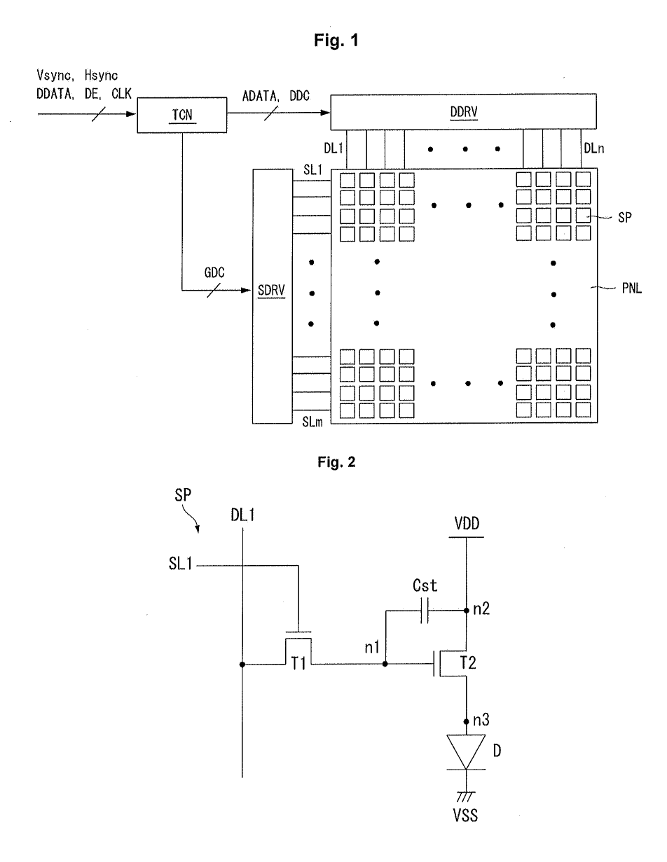

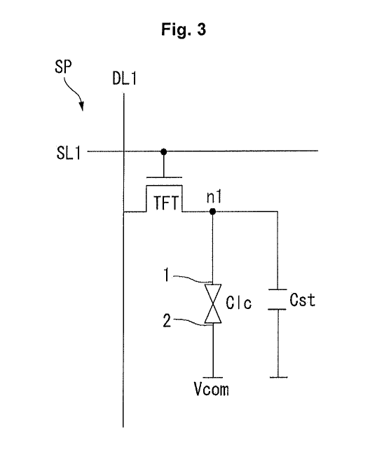

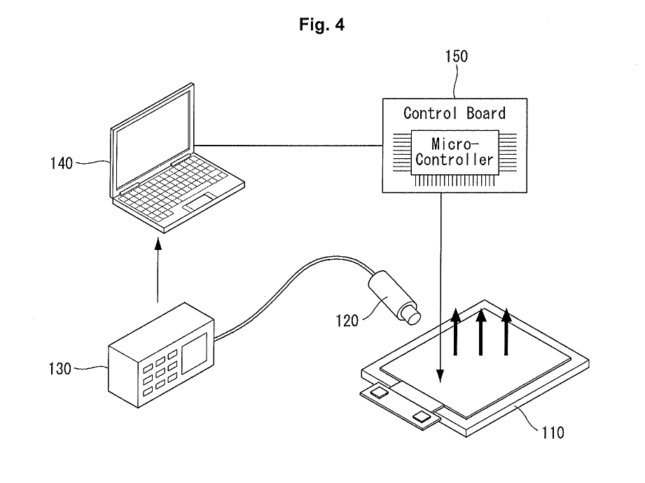

FIG. 1 is a schematic block diagram illustrating a display device according to an implementation of this document, FIG. 2 is a diagram illustrating a subpixel circuit configuration of an OLED panel according to an implementation of this document, and FIG. 3 is a diagram illustrating a subpixel circuit configuration of an LCD panel according to an implementation of this document.

As shown in FIG. 1, the display device comprises a timing driver TCN, a gate driver SDRV, a data driver DDRV, and a panel PNL.

The timing driver TCN receives a vertical synchronous signal Vsync, a horizontal synchronous signal Hsync, a data enable signal DE, a clock signal CLK, and a data signal DDATA from the outside. The timing driver TCN controls operation timing of the data driver DDRV and the gate driver SDRV using a timing signal such as the vertical synchronous signal Vsync, the horizontal synchronous signal Hsync, the data enable signal DE, and the clock signal CLK. Because the timing driver TCN can determine a frame period by counting a data enable signal DE of one horizontal period, the vertical synchronous signal Vsync and the horizontal synchronous signal Hsync supplied from the outside may be omitted. Control signals generated in the timing driver TCN comprise a gate timing control signal GDC for controlling operation timing of the gate driver SDRV and a data timing control signal DDC for controlling operation timing of the data driver DDRV. The gate timing control signal GDC comprises a gate start pulse GSP, a gate shift clock GSC, a gate output enable signal GOE, etc. The gate start pulse GSP is supplied to a gate drive integrated circuit (IC) in which a first gate signal occurs. The gate shift clock GSC is a clock signal commonly input to gate drive ICs and is a clock signal for shifting a gate start pulse GSP. The gate output enable signal GOE controls an output of the gate drive ICs. The data timing control signal DDC comprises a source start pulse SSP, a source sampling clock SSC, a source output enable signal SOE, etc. The source start pulse SSP controls a data sampling start time point of the data driver DDRV. The source sampling clock SSC is a clock signal for controlling a sampling operation of data within the data driver DDRV based on a rising or falling edge. The source output enable signal SOE controls an output of the data driver DDRV. The source start pulse SSP supplied to the data driver DDRV may be omitted according to a data transmission method.

The gate driver SDRV sequentially generates a gate signal while shifting a level of a signal with a swing width of a gate driving voltage in which transistors of subpixels SP comprised in the panel PNL can be operated in response to a gate timing control signal GDC supplied from the timing driver TCN. The gate driver SDRV supplies a gate signal generated through gate lines SL1-SLm to subpixels SP comprised in the panel PNL. The gate driver SDRV is directly formed in the panel in a gate in panel (GIP) method or is formed in the outside of the panel PNL.

The data driver DDRV samples and latches a data signal DDATA of a digital form supplied from the timing driver TCN and converts the data signal DDATA to data of a parallel data system in response to a data timing control signal DDC supplied from the timing driver TCN. As described above, when the data signal DDATA is converted to data of a parallel data system, the data driver DDRV converts the data signal DDATA of a digital form to a gamma reference voltage and converts the gamma reference voltage to a data signal ADATA of an analog form. The data driver DDRV supplies a data signal ADATA converted through data lines DL1-DLn to subpixels SP comprised in the panel PNL.

The panel PNL comprises red, green, and blue (hereinafter, referred to as ‘RGB’) subpixels SP disposed in a matrix form. The panel PNL comprises an OLED panel or an LCD panel. When the panel PNL is formed as an OLED panel, a subpixel has a circuit configuration of FIG. 2. In a switching transistor T1, a gate is connected to a gate line SL1 to which a gate signal is supplied, one end thereof is connected to a data line DL1 to which a data signal is supplied, and the other end thereof is connected to a first node n1. In a driving transistor T2, a gate is connected to the first node n1, one end thereof is connected to a second node n2 connected to a first power source wiring VDD to which a driving power source Vdd of a high potential is supplied, and the other end thereof is connected to a third node n3. One end of a storage capacitor Cst is connected to the first node n1 and the other end thereof is connected to the second node n2. In an organic light emitting diode D, an anode is connected to the third node n3 connected to the other end of the driving transistor T2, and a cathode is connected to a second power source wiring VSS to which a driving power source Vss of a low potential is supplied. In an OLED panel having such a subpixel SP structure, according to a gate signal supplied through the gate line SL1 and a data signal supplied through the data line DL1, as a light emitting layer comprised in each subpixel emits light, an image is displayed.

Alternatively, when the panel PNL is formed as an LCD panel, a subpixel SP has a circuit configuration of FIG. 3. In a switching transistor TFT, a gate is connected to a gate line SL1 to which a gate signal is supplied and one end thereof is connected to a data line DL1 to which a data signal is supplied, and the other end thereof is connected to a first node n1. One end of a pixel electrode 1 positioned at one side of a liquid crystal cell Clc is connected to the first node n1 connected to the other end of the switching transistor TFT, and a common electrode 2 positioned at the other side of the liquid crystal cell Clc is connected to a common voltage wiring Vcom. One end of a storage capacitor Cst is connected to the first node n1, and the other end thereof is connected to the common voltage wiring Vcom. The LCD panel having such a subpixel SP structure can display an image with transmission of light according to a change of a liquid crystal layer comprised in each subpixel according to a gate signal supplied through the gate line SL1 and a data signal supplied through the data line DL1.

In the foregoing description, for a better understanding of a subpixel, FIGS. 2 and 3 illustrate a common circuit configuration, and the implementation is not limited thereto.

In order to express desired luminance and color coordinate, a display device comprising the above-described OLED panel or LCD panel sets a gamma value (corrects a color) and displays, when a set gamma value is stored in a memory, a screen with reference to the gamma value stored in the memory whenever driving.

Hereinafter, a method of setting gamma of a display device will be described.

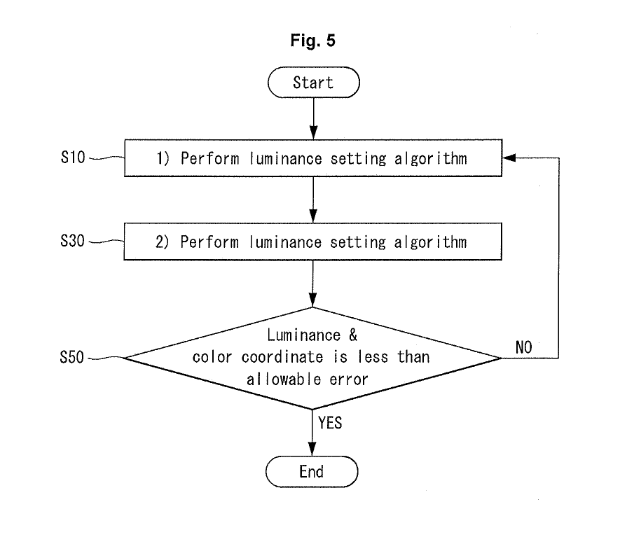

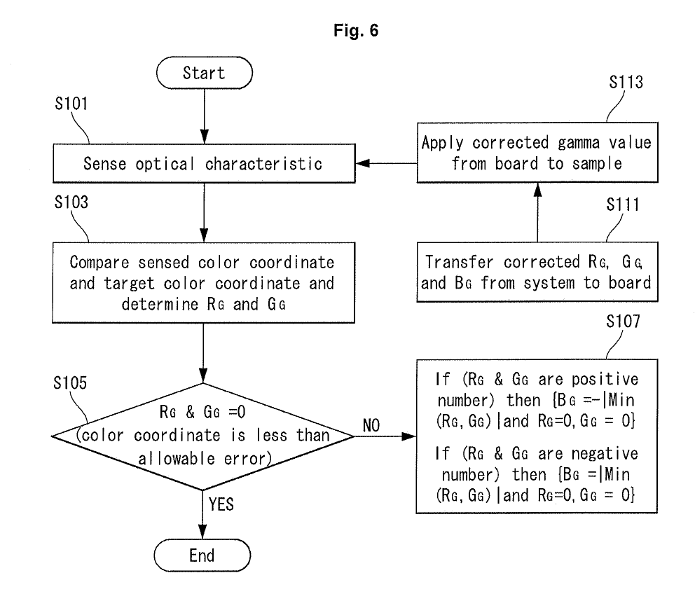

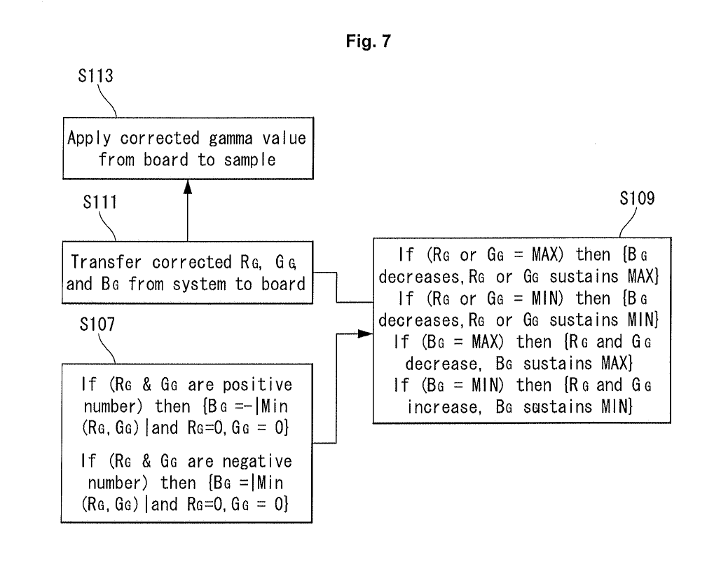

FIG. 4 is a diagram illustrating a configuration of a device for setting gamma of a display device according to an implementation of this document, FIG. 5 is a flowchart illustrating a method of setting gamma according to an implementation of this document, and FIGS. 6 and 7 are flowcharts illustrating a method of setting gamma according to an implementation of this document.

As shown in FIGS. 4 and 5, the gamma setting device of a display device comprises a sensing unit 120, an optical measuring unit 130, a processor 140, and a board 150.

The gamma setting device of the display device senses an optical characteristic (color coordinate) displayed in a display module 110 using the sensing unit 120. The optical characteristic sensed by the sensing unit 120 is converted to data of a digital signal form by the optical measuring unit 130 and is transferred to the processor 140.

The processor 140 provides a sensed color coordinate of the display module 110 based on data transferred from the optical measuring unit 130, sets a gamma value appropriate for the display module 110 by comparing the sensed color coordinate and a target color coordinate and a gamma value through the board 150, and stores the gamma value in a memory of a data driver comprised in the display module 110 through the board 150. Here, a computer that can check, correct, and output a result through input data can be used as the processor 140, but the processor 140 is not limited thereto. An external memory or an internal memory comprised in the data driver can be selected as the memory of the data driver, but the memory of the data driver is not limited thereto.

An OLED panel or an LCD panel comprising the panel PNL, the data driver DDRV, and the gate driver SDRV described with reference to FIG. 1 can be selected as the display module 110, but the display module 110 is not limited thereto. Here, the display module 110 is driven by a pattern generator, etc., and thus an RGB subpixel is displayed over a specific area or an entire panel PNL, but it is not limited thereto.

A method of setting gamma finds a gamma value appropriate for the display module 110 by repeatedly performing a series of process of FIG. 5 using the above device.

As shown in FIG. 5, the method of setting gamma is generally performed with step of performing luminance setting algorithm (S10), step of performing color coordinate setting algorithm (S30), and determining whether luminance & a color coordinate satisfy an allowable error (S50).

In order to set a target optical characteristic for the display module 110, luminance is set and then a color coordinate is set, as described above. If luminance and a color coordinate satisfy an allowable error, gamma setting is terminated and a value that is set at this time is stored in the memory of the data driver through the board 150. If luminance and a color coordinate do not satisfy an allowable error, the process returns to step S10.

As shown in FIGS. 6 and 7, the method of setting gamma of the display device according to an implementation of this document is performed in order of step of sensing (S101), step of determining a fluctuation value of RG gamma (S103), step of determining (S105), step of first correction (S107), step of second correction (S109), and step of applying (S111 and S113).

Hereinafter, a method of setting gamma of a display device will be described in detail with reference to FIGS. 1 to 7.

Step of sensing (S101) is step of sensing an optical characteristic from the display module 110. Step of sensing (S101) is performed by sensing an optical characteristic displayed in the display module 110 with the sensing unit 120. An optical characteristic of the display module 110 sensed by the sensing unit 120 is converted to data of a digital signal form by the optical measuring unit 130 and is transferred to the processor 140.

Step of determining a fluctuation value of RG gamma (S103) compares a color coordinate sensed at sensing step (S101) and a target color coordinate and determines a fluctuation value RG of R gamma and a fluctuation value GG of G gamma. At step of determining a fluctuation value of RG gamma (S103), by comparing a sensed color coordinate and a target color coordinate, a fluctuation value RG of R gamma and a fluctuation value GG of G gamma are determined.

Step of determining (S105) is step of determining whether a fluctuation value RG of R gamma and a fluctuation value GG of G gamma determined at step of determining a fluctuation value of RG gamma (S103) satisfy an allowable error. At step of determining (S105), if a fluctuation value RG of R gamma and a fluctuation value GG of G gamma determined at step of determining a fluctuation value of RG gamma (S103) satisfy an allowable error, the following correction step is not performed and the process is terminated.

A figure illustrating step of determining (S105) illustrates that an allowable error of the fluctuation value RG of R gamma and the fluctuation value GG of G gamma is 0, but the allowable error is set as α, which is a value of 1 or less comprising a decimal point instead of 0, and this can be changed according to a request characteristic of a product. However, in the implementation, for a better understanding, it is described as the allowable error is 0.

If the fluctuation value RG of R gamma and the fluctuation value GG of G gamma do not satisfy an allowable error at step S105, the fluctuation value RG of R gamma and the fluctuation value GG of G gamma are corrected (S107). If the fluctuation value RG of R gamma and the fluctuation value GG of G gamma are a positive number at step S107, a fluctuation value BG of B gamma is lowered, and if the fluctuation value RG of R gamma and the fluctuation value GG of G gamma are a negative number, a fluctuation value BG of B gamma is raised.

If the fluctuation value RG of R gamma and the fluctuation value GG of G gamma are a positive number at step S107, the fluctuation value BG of B gamma is lowered with a method of lowering the fluctuation value RG of R gamma and the fluctuation value GG of G gamma, and if the fluctuation value RG of R gamma and the fluctuation value GG of G gamma are a negative number, the fluctuation value BG of B gamma is raised with a method of raising the fluctuation value RG of R gamma and the fluctuation value GG of G gamma.

First correction step (S107) is performed based on Equation 1.

If (RG & GG are positive number) then {BG=−|Min(RG,GG)| and RG=0, GG=0},

If (RG & GG are negative number) then {BG=|Min(RG,GG)| and RG=0, GG=0} [Equation 1]

In Equation 1, RG is a fluctuation value of R gamma, GG is a fluctuation value GG of G gamma, and |Min(RG, GG)| is a function of returning an absolute value of a smaller value of a fluctuation value of R gamma and a fluctuation value GG of G gamma.

As can be seen in Equation 1, a method of setting gamma of a display device according to an implementation uses a characteristic that if a fluctuation value RG of R gamma is raised, an X color coordinate rises, if a fluctuation value RG of R gamma is lowered, an X color coordinate falls, if a fluctuation value GG of G gamma is raised, a Y color coordinate rises, if a fluctuation value GG of G gamma is lowered, a Y color coordinate falls, if a fluctuation value BG of B gamma is raised, an XY color coordinate falls, and if a fluctuation value BG of B gamma is lowered, an XY color coordinate rises.

At second correction step (S109), if one of the fluctuation value RG of R gamma and the fluctuation value GG of G gamma becomes a gamma maximum value MAX at step S107, the fluctuation value BG of B gamma is lowered, and if one of the fluctuation value RG of R gamma and the fluctuation value GG of G gamma becomes a gamma minimum value MIN, the fluctuation value BG of B gamma is raised. Further, if the fluctuation value BG of B gamma becomes a gamma maximum value MAX, the fluctuation value RG of R gamma and the fluctuation value GG of G gamma are lowered, and if the fluctuation value BG of B gamma becomes a gamma minimum value MIN, an addition correction is performed in a form of raising the fluctuation value RG of R gamma and the fluctuation value GG of G gamma.

If one of the fluctuation value RG of R gamma and the fluctuation value GG of G gamma becomes a gamma maximum value MAX at step S109, one of the fluctuation value RG of R gamma and the fluctuation value GG of G gamma sustains the gamma maximum value MAX, and if one of the fluctuation value RG of R gamma and the fluctuation value GG of G gamma becomes a gamma minimum value MIN, one of the fluctuation value RG of R gamma and the fluctuation value GG of G gamma sustains the gamma minimum value MIN. If the fluctuation value BG of B gamma becomes a gamma maximum value MAX, the fluctuation value BG of B gamma sustains the gamma maximum value MAX, and if the fluctuation value BG of B gamma becomes a gamma minimum value MIN, the fluctuation value BG of B gamma sustains the gamma minimum value MIN.

Second correction step S109 is performed based on Equation 2.

If (RG or GG=MAX) then {BG decreases, RG or GG sustains MAX},

If (RG or GG=MIN) then {BG increases, RG or GG sustains MIN},

If (BG=MAX) then {RG and GG decrease, BG sustains MAX},

If (BG=MIN) then {RG and GG increase, BG sustains MIN}, [Equation 2]

In Equation 2, RG is a fluctuation value RG of R gamma, GG is a fluctuation value GG of G gamma, BG is a fluctuation value BG of B gamma, Min is a gamma minimum value MIN, and MAX is a gamma maximum value MAX.

As can be seen in Equation 2, if one of the fluctuation value RG of R gamma and the fluctuation value GG of G gamma arrives at a gamma minimum value MIN or a gamma maximum value MAX, a method of setting gamma of a display device according to an implementation lowers or raises other values while sustaining a corresponding value.

When gamma by the fluctuation value RG of R gamma and the fluctuation value GG of G gamma corrected at first correction step S107 arrives at a limit value, second correction step S109 is performed and thus may be omitted.

Step of applying (S111, S113) is step of applying an R gamma value, a G gamma value, and a B gamma value corrected at second correction step S109 to the display module 110.

Step of applying (S111, S113) comprises step of transferring a fluctuation value RG of R gamma, a fluctuation value GG of G gamma, and a fluctuation value BG of B gamma corrected at second correction step S109 from a system to a board (S111) and step of generating a corrected fluctuation value RG of R gamma, fluctuation value GG of G gamma, and fluctuation value BG of B gamma into a corrected R gamma value, G gamma value, and B gamma value using firmware existing in a board and storing the corrected R gamma value, G gamma value, and B gamma value in the display module 110 (S113).

Step of transferring (S111) is step of transferring the corrected fluctuation value RG of R gamma, fluctuation value GG of G gamma, and fluctuation value BG of B gamma from the processor 140 to be a system to the board 150 to be a board. Accordingly, firmware existing in the board 150 generates a corrected R gamma value, G gamma value, and B gamma value by applying the fluctuation value RG of R gamma, the fluctuation value GG of G gamma, and the fluctuation value BG of B gamma transferred from the processor 140 to an R gamma value, a G gamma value, and a B gamma value, respectively.

Step of storing (S113) is step of storing the corrected R gamma value, G gamma value, and B gamma value in a memory of the data driver DDRV comprised in the display module 110 to be a sample using the board 150 to be a board and applying the corrected gamma value.

As described above, a method of setting gamma of a display device according to an implementation of this document is performed in order of step of sensing (S101), step of determining a fluctuation value of RG gamma (S103), step of determining (S105), first correction step (S107), second correction step (S109), and step of applying (S111, S113). The process is repeatedly performed in the above order until the fluctuation value RG of R gamma and the fluctuation value GG of G gamma satisfy an allowable error.

In the method of setting gamma of a display device according to an implementation of this document, step of determining a fluctuation value of RG gamma (S103), step of determining (S105), first correction step (S107), and second correction step (S109) are performed by actual algorithm on an operating system (OS) of the processor 140 to be a system. Further, the method of setting gamma of a display device according to an implementation of this document is performed with a method of determining the fluctuation value RG of R gamma and the fluctuation value GG of G gamma and then determining the fluctuation value BG of B gamma.

Table 1 is a result table of an experiment of a target optical characteristic adjustment consumption time and arrival at a limitation value (determination as bad panel) on a panel basis with a method of setting gamma by a conventional method and a method of setting gamma according to this document.

TABLE 1

| | | | Method according to this | |
|---|---|---|---|---|
| | Conventional method | | document | |
| | Target optical | Arrival at | Target optical | Arrival at |
| | characteristic | limitation | characteristic | limitation |
| | adjustment | value(deter- | adjustment | value(deter- |
| Panel | consumption | mination as | consumption | mination as |
| # | time (sec) | bad panel) | time (sec) | bad panel) |
| 1 | 120 | good | 108 | good |
| 2 | 122 | good | 107 | good |
| 3 | 121 | good | 110 | good |
| 4 | 118 | good | 100 | good |
| 5 | 118 | good | 101 | good |
| 6 | 130 | bad | 101 | good |
| 7 | 117 | good | 108 | good |
| 8 | 116 | good | 100 | good |
| 9 | 114 | good | 99 | good |
| 10 | 125 | bad | 111 | good |
| 11 | 114 | good | 105 | good |
| 12 | 128 | good | 105 | good |
| 13 | 119 | good | 107 | good |
| 14 | 131 | good | 100 | good |
| 15 | 124 | good | 109 | good |
| 16 | 124 | good | 100 | good |
| 17 | 129 | good | 110 | good |
| 18 | 118 | good | 105 | good |
| 19 | 122 | good | 101 | good |
| 20 | 118 | bad | 106 | good |
| 21 | 122 | good | 100 | good |
| 22 | 131 | good | 100 | good |
| 23 | 118 | good | 98 | good |
| 24 | 117 | good | 106 | good |
| 25 | 126 | bad | 110 | bad |
| 26 | 129 | good | 107 | good |
| 27 | 129 | good | 107 | good |
| 28 | 117 | good | 103 | good |
| 29 | 121 | good | 102 | good |
| 30 | 130 | good | 100 | good |
| Average | 122 | 4 | 104 | 1 |

As can be seen in Table 1, in a method according to this document, an average consumption time is good as 104 seconds and a bad panel determining rate according to arrival at a limitation value is very good as 1, compared with a conventional method.

Therefore, in the method of setting gamma of a display device according to an implementation, a time consumed for setting gamma can be reduced, compared with a conventional method and thus a system quantity, an operator, and operation space can be remarkably reduced, and because an addition device configuration or algorithm setting is unnecessary, the method has a merit in an installation cost. Further, because the method of setting gamma of a display device according to an implementation can approach a more accurate target value, compared with a conventional method, an allowable error can be remarkably reduced, and a high quality of product can be provided. Further, because the method of setting gamma of a display device according to an implementation can effectively avoid from arriving at a gamma limitation value when setting gamma, compared with a conventional method, a yield of a product can be improved.

As described above, according to this document, a method of setting gamma of a display device that can expect reduction of a time consumed for setting gamma, reduction of an installation cost, improvement of accuracy according to decrease of an allowable error, and improvement of a yield through escaping of arrival at a gamma limitation value is provided.

The foregoing implementations and advantages are merely exemplary and are not to be construed as limiting this document. The present teaching can be readily applied to other types of apparatuses. The description of the foregoing implementations is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. A method of setting gamma of a display device, the method comprising:
sensing an optical characteristic from a display module;
comparing a color coordinate sensed at the sensing of an optical characteristic and a target color coordinate and determining a fluctuation value of R gamma and a fluctuation value of G gamma of RGB gamma;
determining whether the fluctuation value of R gamma and the fluctuation value of G gamma determined at the determining of a fluctuation value satisfy an allowable error;
first correcting of correcting, if the fluctuation value of R gamma and the fluctuation value of G gamma do not satisfy an allowable error, the fluctuation value of R gamma and the fluctuation value of G gamma, and lowering, if the fluctuation value of R gamma and the fluctuation value of G gamma are a positive number, a fluctuation value of B gamma, and raising, if the fluctuation value of R gamma and the fluctuation value of G gamma are a negative number, a fluctuation value of B gamma;
second correcting of lowering, if one of the fluctuation value of R gamma and the fluctuation value of G gamma arrives at a gamma maximum value at the first correcting, the fluctuation value of B gamma, and raising, if one of the fluctuation value of R gamma and the fluctuation value of G gamma arrives at a gamma minimum value, the fluctuation value of B gamma, and lowering, if the fluctuation value of B gamma arrives at a gamma maximum value, the fluctuation value of R gamma and the fluctuation value of G gamma, and raising, if the fluctuation value of B gamma arrives at a gamma minimum value, the fluctuation value of R gamma and the fluctuation value of G gamma; and
applying RGB gamma corrected at the second correcting to the display module.

2. The method of claim 1, wherein at the first correcting,
if the fluctuation value of R gamma and the fluctuation value of G gamma are a positive number, the fluctuation value of B gamma is lowered with a method of lowering the fluctuation value of R gamma and the fluctuation value of G gamma; and
if the fluctuation value of R gamma and the fluctuation value of G gamma are a negative number, the fluctuation value of B gamma is raised with a method of raising the fluctuation value of R gamma and the fluctuation value of G gamma.

3. The method of claim 1, wherein the first correcting is performed based on an Equation of if (R_{G} & G_{G} are positive number) then {B_{G}=−|Min(R_{G}, G_{G})| and R_{G}=0, G_{G}=0} and if (R_{G} & G_{G} are negative number) then {B_{G}=|Min(R_{G}, G_{G})| and R_{G}=0, G_{G}=0},
where the R_{G} is a fluctuation value of R gamma, G_{G} is a fluctuation value of G gamma, and the |Min(R_{G}, G_{G})| is a function that returns an absolute value of a small value of the fluctuation value of R gamma and the fluctuation value of G gamma.

4. The method of claim 1, wherein at the second correcting,
if one of the fluctuation value of R gamma and the fluctuation value of G gamma arrives at a gamma maximum value, one of the fluctuation value of R gamma and the fluctuation value of G gamma sustains the gamma maximum value,
if one of the fluctuation value of R gamma and the fluctuation value of G gamma arrives at a gamma minimum value, one of the fluctuation value of R gamma and the fluctuation value of G gamma sustains the gamma minimum value,
if the fluctuation value of B gamma arrives at a gamma maximum value, the fluctuation value of B gamma sustains the gamma maximum value, and
if the fluctuation value of B gamma arrives at a gamma minimum value, the fluctuation value of B gamma sustains the gamma minimum value.

5. The method of claim 1, wherein the second correcting is performed based on an Equation of if (R_{G} or G_{G}=MAX) then {B_{G} decreases, R_{G} or G_{G} sustains MAX}, if (R_{G} or G_{G}=MIN) then {B_{G} increases, R_{G} or G_{G} sustains MIN}, if (B_{G}=MAX) then {R_{G} and G_{G} decreases, B_{G} sustains MAX}, and if (B_{G}=MIN) then {R_{G} and G_{G} increase, B_{G} sustains MIN},
where the R_{G} is a fluctuation value of R gamma, G_{G} is a fluctuation value of G gamma, and the Min is a gamma minimum value, and the MAX is a gamma maximum value.

6. The method of claim 1, wherein the sensing, the determining of a fluctuation value, the determining, the first correcting, the second correcting, and the applying of RGB gamma are repeated until the fluctuation value of R gamma and the fluctuation value of G gamma satisfy an allowable error.

7. The method of claim 1, wherein the applying of RGB gamma comprises:
transferring the corrected fluctuation value of R gamma, fluctuation value of G gamma, and fluctuation value of B gamma from a system to a board; and
generating the corrected fluctuation value of R gamma, fluctuation value of G gamma, and fluctuation value of B gamma into a corrected R gamma value, G gamma value, and B gamma value using firmware existing in the board, and storing the corrected R gamma value, G gamma value, and B gamma value in the display module.

8. The method of claim 1, wherein at the determining, if the fluctuation value of R gamma and the fluctuation value of G gamma determined at the determining of a fluctuation value satisfy an allowable error, the first correcting and the second correcting are terminated.

9. The method of claim 1, wherein the display module is one of a module formed with an organic light emitting display panel and a module formed with a liquid crystal display panel.
